(19) United States
(12) Patent Application Publication
(10) Pub. No.: US 2014/0297194 A1
(43) Pub. Date: Oct. 2, 2014

(54) GENE SIGNATURES FOR DETECTION OF POTENTIAL HUMAN DISEASES

(71) Applicant: Yih-Sheng Yang, Plano, TX (US)

(72) Inventor: Yih-Sheng Yang, Plano, TX (US)

(21) Appl. No.: 13/855,679

(22) Filed: Apr. 2, 2013

(51) Int. Cl. G06F 19/20

(52) U.S. Cl. CPC G06F 19/20
USPC 702/19

(57) ABSTRACT

A process to select signature gene by performing statistical analyses on gene datasets of various types of diseases for identifying signature genes for at least one of the diseases followed by categorizing and establishing gene expression table with the signature genes. The signature genes in the gene expression table are tested and verified by applying additional datasets to finalize and confirm the signature genes. The step of performing the statistical analyses on the gene datasets of various types of diseases further comprising a step of performing a total background normalization (TBN) of a relative gene expression (RGE) ratio then carried a two-tail T-test of the RGE ratios between the various diseases. The step of identifying the signature gene further comprising a step of carrying out a false positive elimination (FPE) by identifying differently expressed genes and removing overlapping genes among different diseases from a list of the signature genes

This patent application is a non-provisional application and claims the priority date of a co-pending Provisional Application 61/618,845 filed on Apr. 2, 2012 by a common inventor of this application. The disclosures made in the Patent Application 61/618,845 are hereby incorporated by reference in this patent application.

### BACKGROUND OF THE INVENTION

1. Field of the Invention

This invention relates generally to microarray technology for exploring and analyzing gene expressions. More particularly, this invention is related to analyzing gene expressions by categorizing and differentiating different gene expressions among broad arrays of genes by using some of the genes associated with known diseases to isolate, categorize, and identify gene signatures for applications in disease detection, treatment and target drug development.

2. Description of the Prior Art

Microarray is a very useful tool for molecular study of the gene expressions in biological cells. Using the technology, it becomes possible to collect enormous amounts of gene expression information present in cells. Genes involved in specific cellular functions or diseases can be categorized for further evaluation. The identified gene unique to a disease would be very useful in clinic for the disease identification, verification, prognosis, and treatment. The main problem, however, was the challenge while analyzing array data. Given the nature of small sample size relative to the number of genes analyzed in an array system, statistical significance of the representative sample size was the main concern. One way to alleviate the problem was increasing the sample size by pooling data from datasets collected from various studies. The approach had setbacks. Many variants as diverse as the sample collection, nucleotides purification and manipulation, experimental design, hybridization conditions, chip setups, image reading, and methods of analysis all could make the background incompatible among datasets. Thus, combining data from different datasets for evaluation was not a commonly approached method, unless the background variation had been properly normalized and minimized for analyses.

Currently there were few methods for array data analysis e.g. clusters analysis, fold change analysis and significance analysis of microarrays (SAM). Ouster analysis could find the expression of genes with coherent pattern in function, but limited by statistical significance (Eisen, M., Spellman, P., Brown, P.&Botstein, D. (1998) Proc. Natl Acad. ScL USA 95, 14863-14868.). Fold change analysis could identify changes in gene expression with statistical significance, but its high false positive rate frequently led to classified genes with little correlation. SAM was designed to categorize class of genes associated with diseases from a relatively small sample size, however, the need of repetitive sampling, paired (matched and mismatched) probes, and multiple probe sets for each gene evaluation raised the cost and effort for analysis (Significance analysis of microarrays applied to the ionizing radiation response (2001) PNAS 98:5116-5121). The majority of array data deposited in public datasets were not performed and collected with paired samples minimizing the use of SAM in analyzing those existing data. Currently there were more than 100,000 human datasets deposited in the public sites and more than 5000 of them were cancer related. Developing a strategy to combine sample data with biological relevance from available datasets for analysis would be very helpful in studying the molecular expression profiles of various diseases.

Many tumor markers are currently identified by the above mentioned methods and are used in biochemical, molecular, cellular, and immunohistochemical studies to examine the change of cell function or morphology. The potential problem of using those markers in clinic is their presence of significant roles in normal or other types of cells. The difficulty of identifying a unique and useful marker to distinguish difference(s) in cells or tissues was evident by finding relatively few overlapped marker(s) in studies from various groups. This problem was not uncommon in studies for various types of cancer including the pancreas ductal adenocarcinoma (PDAC). It was even a more complicated challenge to examine and categorize a sample containing mixed tissues/cells (e.g. normal and diseased) by monitoring the expression profile of such genes. Ideally the best marker gene was found with a distinct expression profile only within typical tissues or cells. Such gene without expression ambiguity could be a potential target for clinical uses.

In this application, simple and comprehensive processes and systems are disclosed to analyze and test large amount of microarray gene expression data. The genes identified by the tests and processes can be applied to identify repeatable and convincing cell-, tissue-, or disease-specific markers which could be used for various applications.

### SUMMARY OF THE PRESENT INVENTION

The disclosed subject matters of this invention provides methods and systems for specifically identifying and defined gene signatures for PDAC by applying statistical differential and categorizing processes on different groups of test samples

One aspect of this invention is to apply the methods and systems on a basis that gene signature exclusive for cells or tissues under a specified condition (e.g. normal, diseased, or artificially managed) could be identified and defined. Therefore, this invention applies the processes and system to identify only the gene with expressions that are differentially occurred exclusively in the specified tissue or cell samples to classify as a disease- or tissue-specific signature gene. In order to achieve that purpose, this invention provides systems and methods to determine any gene with overlapped differential expression within two or more different sample groups to identify the gene not be defined as a marker of gene signature even the level of expression was significantly different from others.

Another aspect of this invention is to provide a system and method to apply to large amount of sample data to improve the accuracy of gene signature identification. The reason is that a statistical categorization process such as a student t-test may be applied to identify differentially expressed gene(s) between two group samples, however, the nature of small size samples and huge amount of genes analyzed in the array system could lead to find hundreds genes with differential expression between any two sample groups. The noise of nonspecific background thus could aggravate the signature gene identification. For that reason, this invention uses a process by comparing multiple sets of t-test results, the false positives can be successfully eliminated (false positive elimination, FPE) and specific signature genes can be identified for a selected sample group, e.g. pancreas ductal adenocarcinoma (PDAC). Further tests demonstrated the value of using such characterized gene signature for the diagnosis of the disease.

Briefly, in a preferred embodiment, the present invention discloses a signature gene selection process by performing statistical analyses on gene data sets of various types of diseases for identifying signature genes for at least one of the diseases followed by categorizing and establishing gene expression table with the signature genes. The processes further comprising steps of further testing and verification of the signature genes in the gene expression table by applying additional data sets to finalize and confirm the signature genes. In an embodiment, the step of performing the statistical analyses on the gene data sets of various types of diseases further comprising a step of performing a total background normalization (TBN) of a relative gene expression (RGE) ratio then carried a two-tail T-test of the RGE ratios between the various diseases. In another embodiment, the step of identifying the signature gene further comprises a step of carrying out a false positive elimination (FPE) by identifying differently expressed genes and removing overlapping genes among different diseases from a list of the signature genes. The gene signature identified by this method could be successfully used to categorize the status of PDAC and to predict patient prognosis.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

The Patent Application filed contains four drawings executed in color. Copies of this Patent Application publication with color drawings will be provided by the Office upon request and payment of the necessary fee.

FIG. 1 is a flowchart to illustrate the processing steps of identifying and classifying signature genes for a specific group of samples;

FIG. 1A is a functional diagram for showing a system and the processes and data paths to carryout the processing steps illustrated in FIG. 1.

FIG. 2 is a flowchart for showing the processing steps to carry out the signature gene identification.

FIG. 3 is a flowchart to show the processing steps to perform a total-background normalization as a step shown in FIG. 2. The expression counts of all applied probes in an individual sample array were converted to a ratio relative to the average of total gene expression (RGE).

FIG. 4 is a flowchart to show the processing step of false positive elimination as a step shown in FIG. 2 that includes RGE data from a selected group (group A) samples are analyzed by student t-test to distinguish and identify the genes with different expressions from other groups and then the results are combined and searched to identify the genes which were differentially expressed (p<0.01) within the selected group (A), not in others.

FIG. 5 is a flowchart to show the processing steps of signature gene identification. The expression ratio of differentially expressed genes (DER) (Signature genes) in the selected group (A) to others was calculated and defined as up-regulated (DER>2) or down-regulated (DER<0.5) signature gene.

FIG. 6 is a flowchart to show the processing steps of gene confirmation. Two datasets containing relative tissue samples were employed for analysis. The signature genes identified from each dataset were evaluated for overlaps and confirmed for reliability.

FIG. 7 is a flowchart to show the processing steps to carry out a disease verification.

FIG. 8 is a flowchart to illustrate the steps to carryout a disease and Status clarification. The strategy and procedure for disease and its status clarification was basically the same as that of disease verification as that shown in FIG. 7.

FIG. 9 is a diagram showing a. survival time analysis of patients in subgroups III and V whereas the subgroup III and V representing the most and less differentiated PDAC, respectively. PDAC patients are subgrouped into five groups according to their expression profile of signature genes and that show a statistically significant difference between survival curves (P=0.049).

Table I lists T-test analysis of PDAC signature gene expression in DB_{—}3 PDAC tumors.

Table II lists T-test analysis of pancreas normal tissue-specific gene expression in DB_{—}3 PDAC tumors.

Table III lists T-test analysis of PDAC signature gene expression in normal pancreas tissues.

Table IV lists T-test analysis of pancreas normal tissue-specific gene expression in normal pancreas tissues.

Table V lists Expression of housekeeping genes in various tumors and normal pancreas tissue.

### DETAILED DESCRIPTION OF THE PREFERRED EMBODIMENT

Descriptions of embodiments of the present invention disclose systems and methods to provide new and improved processes to categorize; differentiate; and identify specific gene expressions specifically in an embodiment for PDAC. The system and methods are applicable to signature gene identification for other diseases and biological conditions. In these embodiments, systematic approaches are developed to carry out multiple stages of statistical categorization tests and false positive eliminations to specifically and more accurately determine the signature genes.

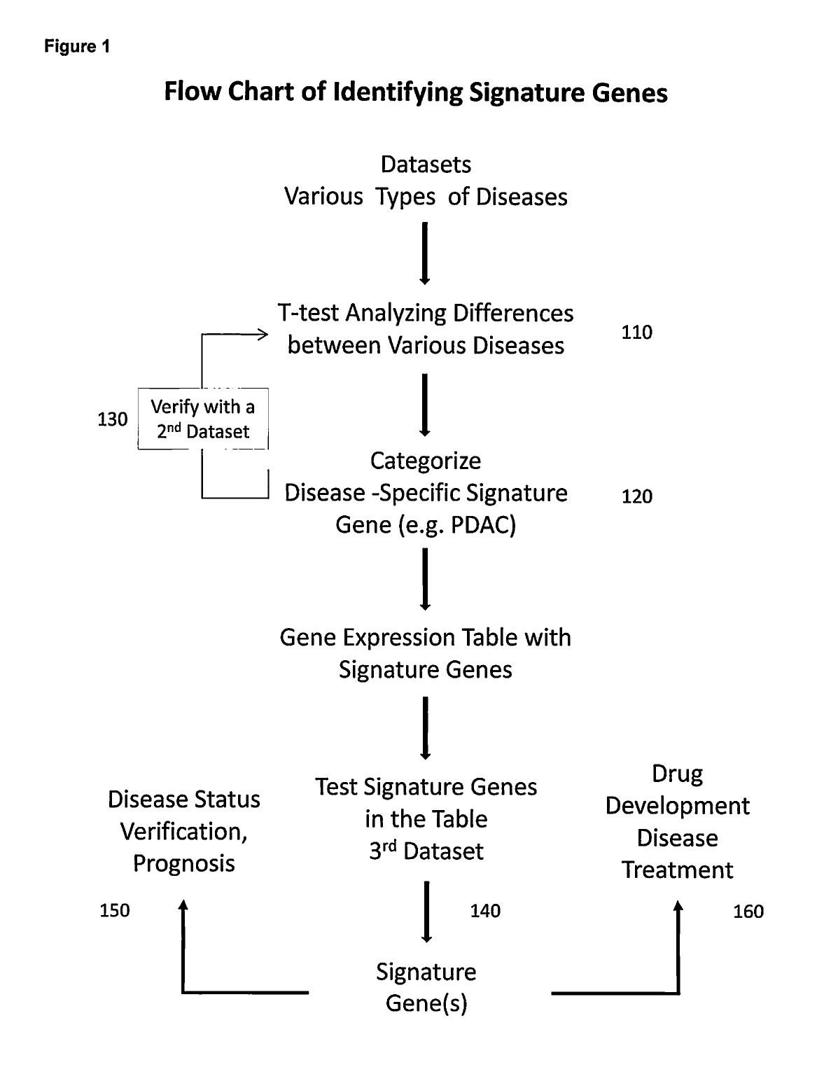

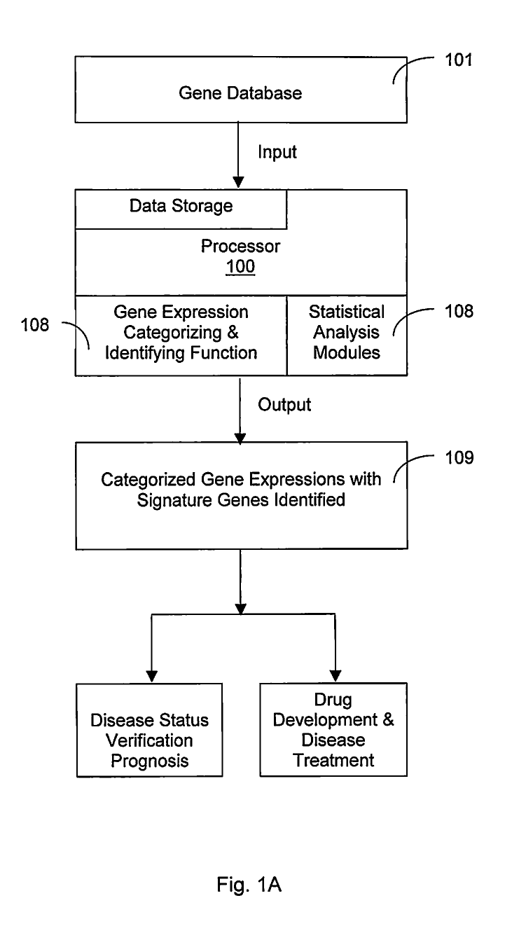

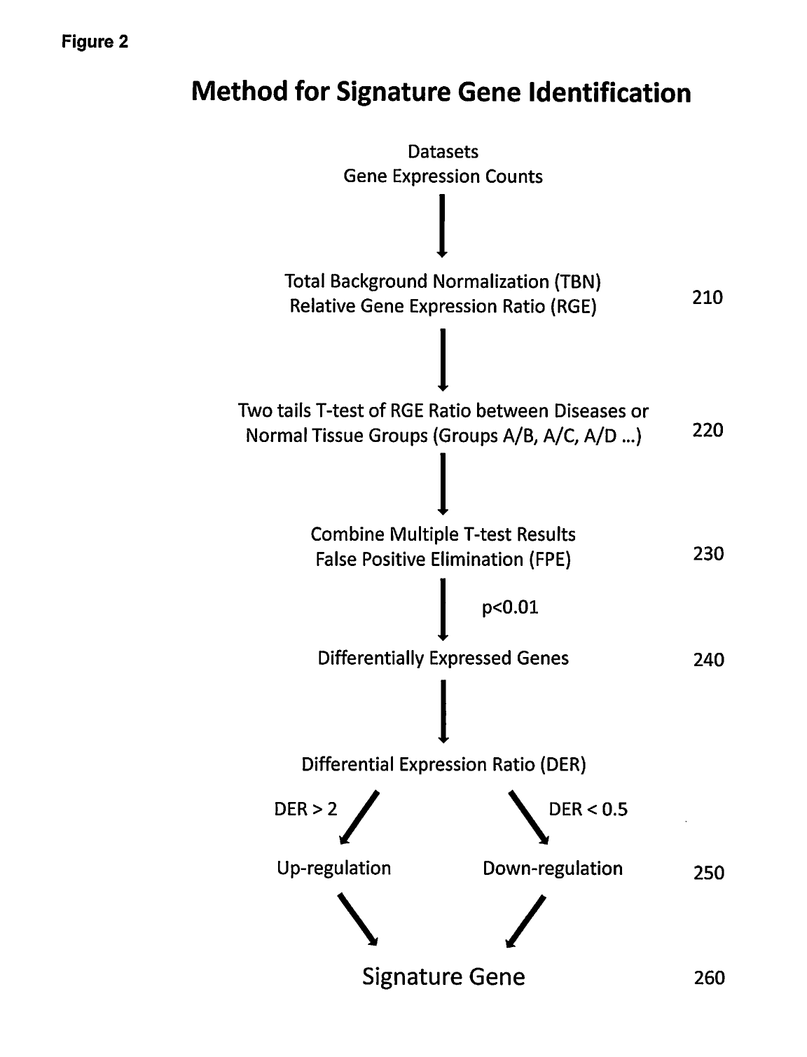

FIGS. 1 and 2 illustrate processes for applying to data array of PDAC as an example to elucidate the method and demonstrate the processes that signature genes specific for PDAC, or any disease, are characterized and classified. FIG. 1A is a functional block diagram of a data processing system to carry out the processes of statistical processes applied to array data collected from an individual or combined datasets. The processes start with a step of receiving input from a gene database 101 that includes two groups of sample into a processor that includes a gene expression categorizing and identifying functional unit 105 as shown in FIG. 1A that execute statistical analyses by invoking a statistical analysis module 108. The results of analyses 109 are outputted from the processor 100 as categorized gene expressions with signature genes identified. As shown in FIG. 1, the processor for performing gene expression categorizing and identifying functions carries out a student t-test analysis on the data of these two groups of samples. The student t-test was used to distinguish genes which were differentially expressed between two groups of sample (step 110). Those genes with gene expressions that occur only differentially in the specified-disease sample group but not in other analyzed groups are categorized as disease-specific signature gene (step 120). The signature genes categorized by step 120 are then verified by inputting to the gene expression categorizing and identification processor 100 for repeating the student t-test process with a second group of data with the same disease (step 130). The verified signature genes categorized by step 140 in the gene expression table are further inputted to the gene expression categorizing and identification processor 100 for repeating the student t-test process with samples from a third dataset to confirm that the categorized genes were capable of classifying the disease (step 140). Such identified signature genes in the gene expression table then were suitable for disease verification and prognosis (step 150), as well as for drug development (step 160).

FIG. 1A shows an embodiment wherein the database 101 comprises a database (DB_{—}1, GSE2109) which contains microarray data from more than 2000 cancer patient samples including at least 14 types of cancer and more than 54,000 gene probes are used at the initial step to identify genes specific for PDAC (patient sample size N=10). Assuming the background variations associated with each sample preparation, protocols processing, chip set, hybridization, and data measurement had equal effect on all probes used for the sample gene expression measurement, then the differences could be minimized by converting expression value to a relative gene expression ratio (RGE ratio=gene expression value/averaged total expression value, total background normalization (TBN)) for each individual sample as further described and shown in FIG. 2. All data obtained from the public databases for this study were converted to the RGE ratio without any additional manipulation. Each probe RGE ratio from grouped samples were then examined for differential expression between PDAC and various type of cancers or tissues by two-tails t-test analysis. Any probe identified with significant difference in expression (p<0.01) between PDAC and other cancers including, but not restricted to, breast large cell adenocarcinoma (BreLC, N=40), breast ductal carcinoma her2 negative (BDCH2(−), N=l 17), breast ductal carcinoma her2 positive (BDCH2(+), N=53), cervical squamous carcinoma (CerSqu, N=20), colon adenocarcinoma (ColAd, N=218), colon mucinous carcinoma (ColMu, N=37), kidney conventional (clear cell) renal carcinoma (KidCC, N=210), liver hepatocyte carcinoma (LivHC, N=l 1), lung adenocarcinoma (LungAd, N=51), lung squamous carcinoma (LungSq, N=40), ovarian endometrial carcinoma (OvaEndo, N=26), ovarian serous carcinoma (OvaSC, N=78), prostate adenocarcinoma (ProAd, N=72), and uterus endometrial carcinoma (UteEndo, N=104) was selected for further evaluation. The false positive rate (FPR) in randomly claiming a gene differentially expressed between any two sample groups was calculated by equally dividing the ColAd samples (N=218) into two groups and estimated the rate of identifying signature genes with differential expression by t-test analysis using the same condition set as above. The difference in the gene expression level between PDAC and other cancers (differential expression ratio (DER)=PDAC/other cancer)>2 was marked as significantly up-regulated whilst <0.5 as down-regulated in PDAC. T-test results between PDAC and all other types of cancers or normal tissues were then combined, compared, and searched for gene(s) which was only differentially expressed in PDAC. The comparison of combined t-test results could effectively eliminate the false positives, a process named false positive elimination (FPE).

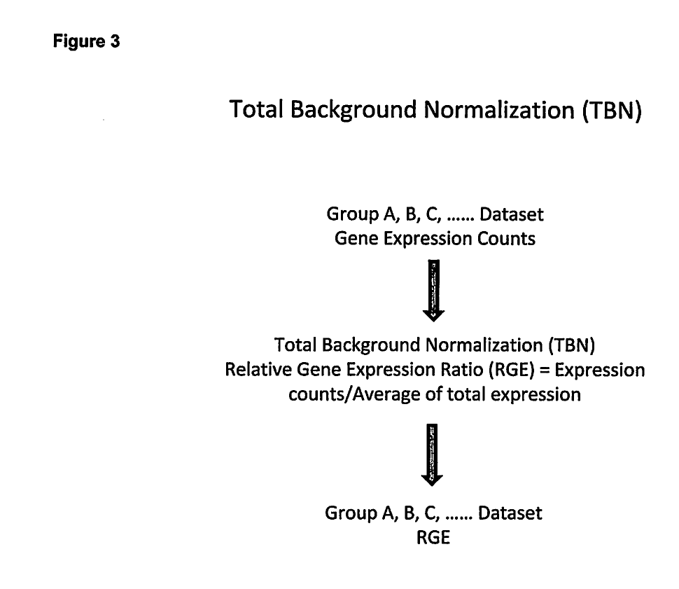

FIG. 2 further shows the method for signature gene identification. The method of analysis for signature gene identification was elucidated in the chart. At first, the gene expression counts of all probes from array data was converted to a relative gene expression (RGE) ratio of the averaged total gene expression (210). The details of this step are shown in FIG. 3 as a flowchart that shows the processing steps to perform a total background normalization. The expression counts of all applied probes in an individual sample array were converted to a ratio relative to the average of total gene expression (RGE).

FIG. 2 shows subsequent steps of performing student t-tests to distinguish genes with differential expression in samples of a selected group (group A) from others (groups B, C, D, . . . .)(Step 220). Tests of all gene probes are included for analysis. The t-test results from multiple sets of evaluation (between A and B, or C, or D, . . . ) are combined, and those genes with p value <0.01 between the selected group (group A) and all others (groups B, C, D, . . . .) are classified as differentially expressed (steps 230 and 240). The expression changes (Differential expression ratio, DER) are defined as up-regulated or down-regulated while DER>2 or <0.5, respectively (step 250). The genes with all specific up-regulation or down-regulation within the selected group (A) when compared to other groups are then categorized as signature genes of the unique group (A) (step 260).

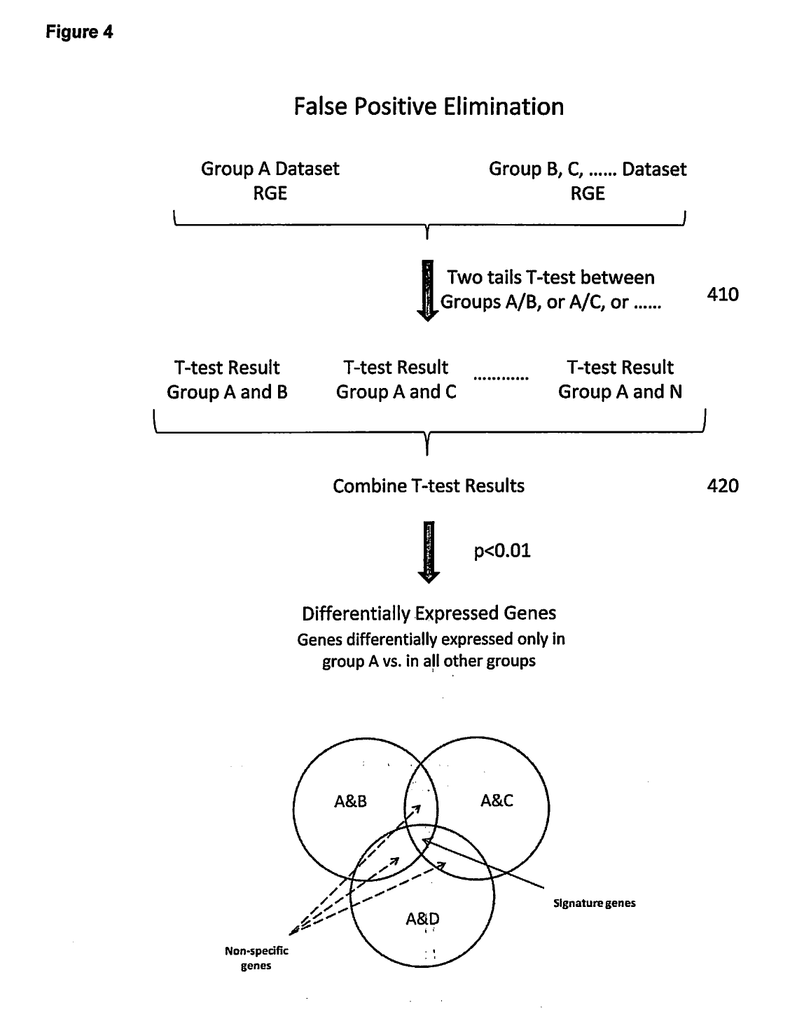

The details of the FPE process (step 230) are shown in FIG. 4 as a flowchart. The RGE data from a selected group (group A) samples were analyzed by student t-test (410) to distinguish and identify the genes whose expressions were different from that of other groups (groups B, C, D, . . . etc). The t-test results from each analysis were then combined and searched to identify the genes which were differentially expressed (p<0.01) within the selected group (A), not in others.

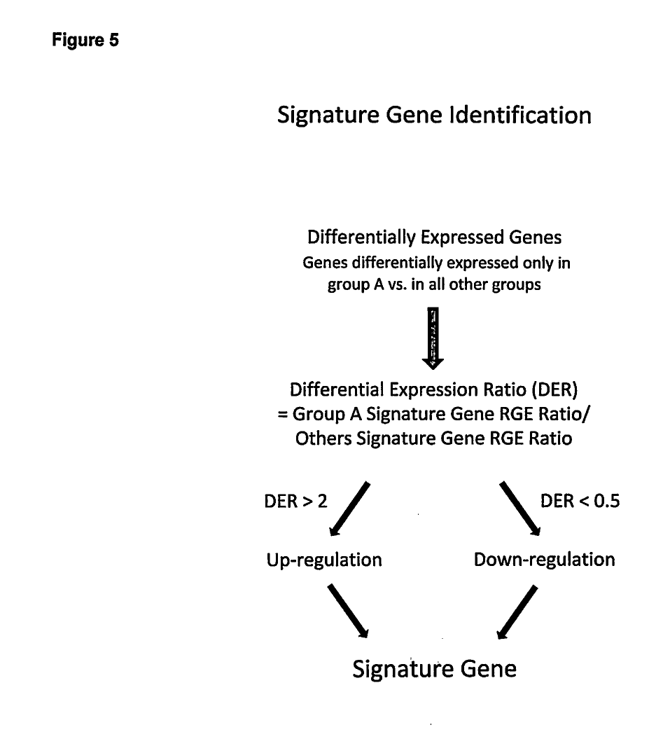

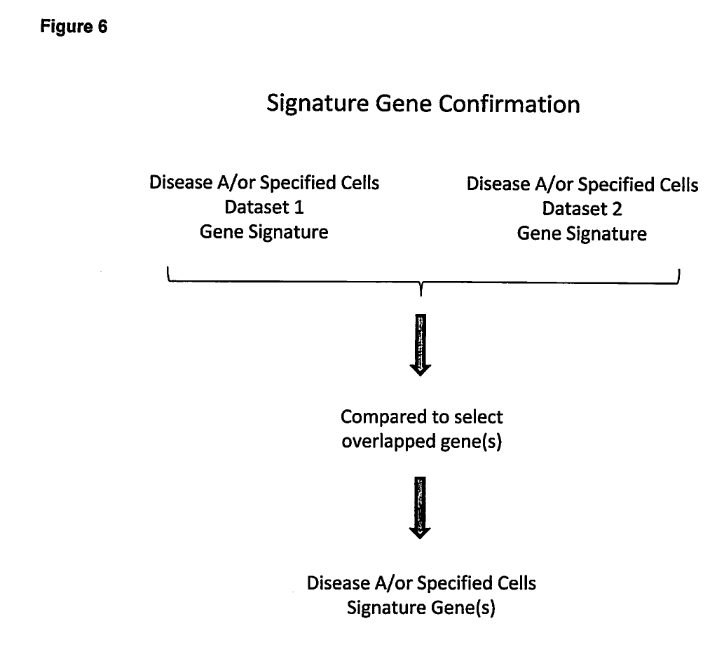

FIG. 5 is a flowchart to show the processing steps of signature gene identification. The expression ratio of differentially expressed genes (DER) (Signature genes) in the selected group (A) to others was calculated and defined as up-regulated (DER>2) or down-regulated (DER<0.5) signature gene. FIG. 6 is a flowchart to show the processing steps of gene confirmation. Two datasets containing relative tissue samples were employed for analysis. The signature genes identified from each dataset were evaluated for overlaps and confirmed for reliability.

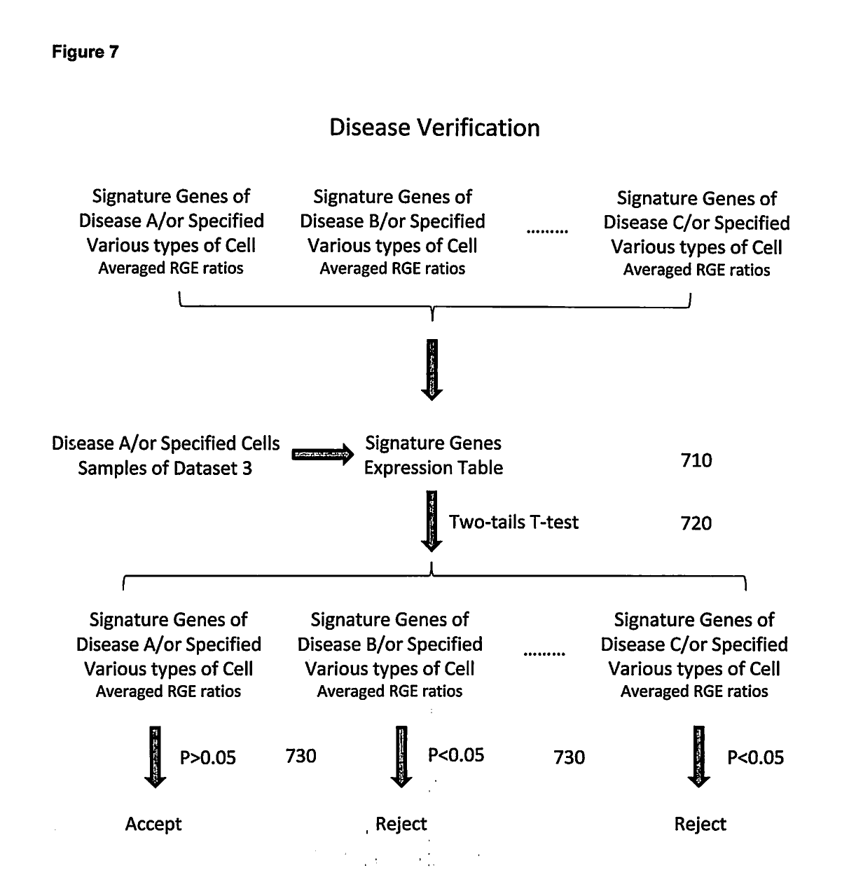

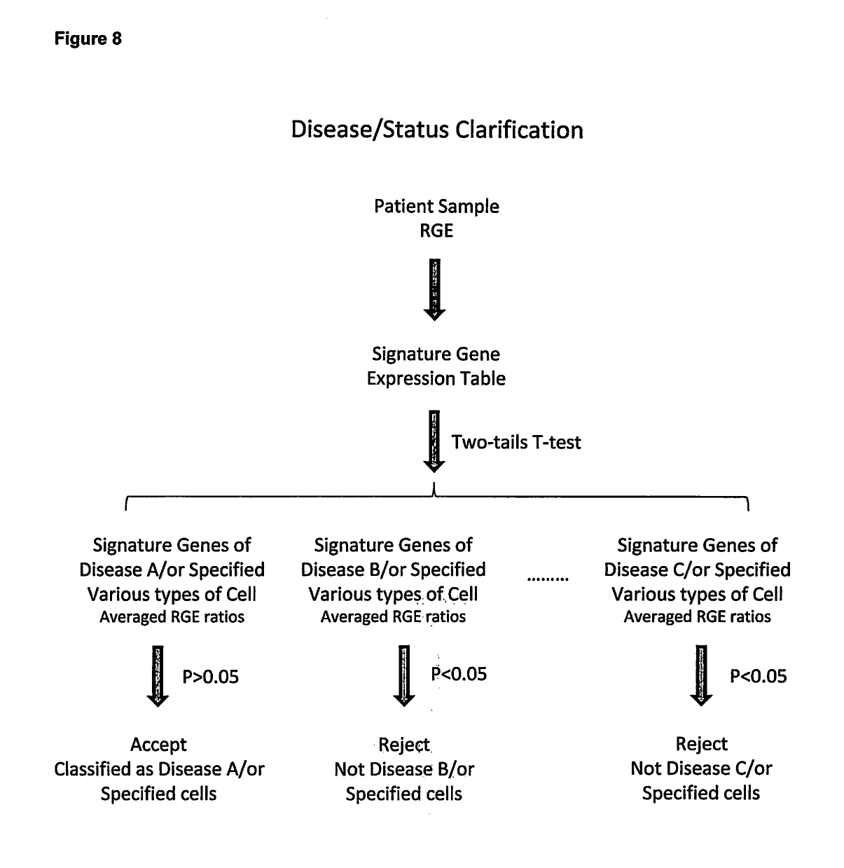

FIG. 7 is a flowchart to show the processing steps to carry out a disease verification. The averaged gene expression of signature genes from various sample groups (Disease A, B, C, . . . .) were summarized in table for data comparison (710). Samples with the same category from a third database were used to test the feasibility and reliability of identifying the disease by the classified signature genes. Two-tail t-test analysis was employed to evaluate the difference in signature genes expression between each sample and various diseases (720). The p-value of t-test>0.05 indicated no difference between the sample and compared disease (730). On the other hand, it suggested the significance in difference from the categorized diseases. FIG. 8 is a flowchart to illustrate the steps to carryout a disease and Status clarification. The strategy and procedure for disease and its status clarification was basically the same as that of disease verification (FIG. 7).

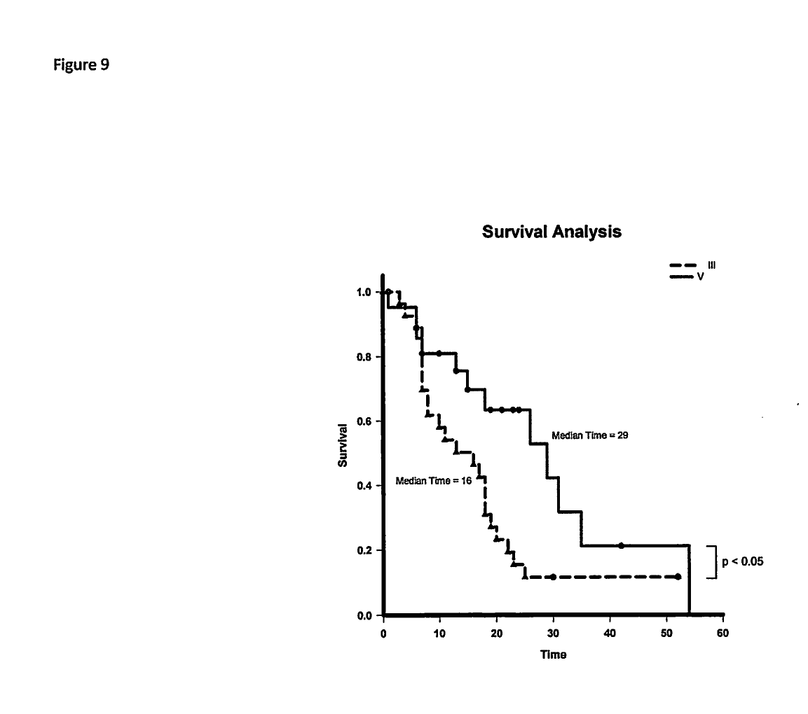

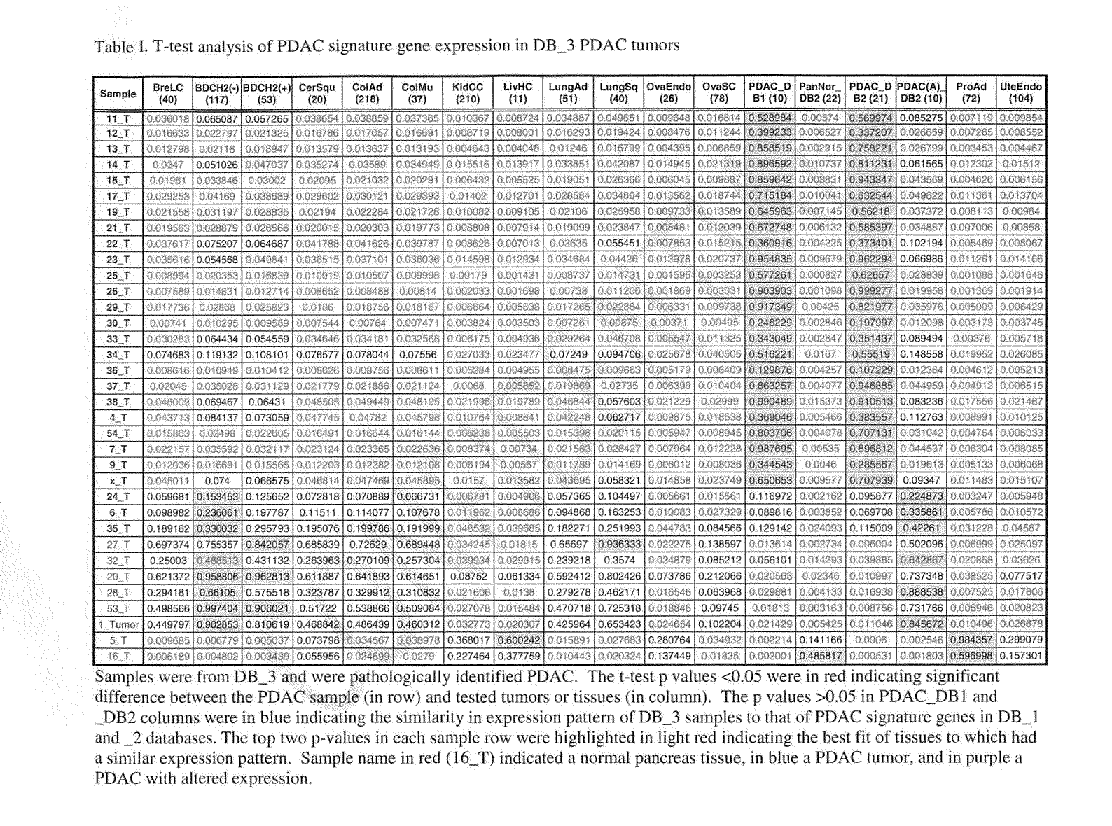

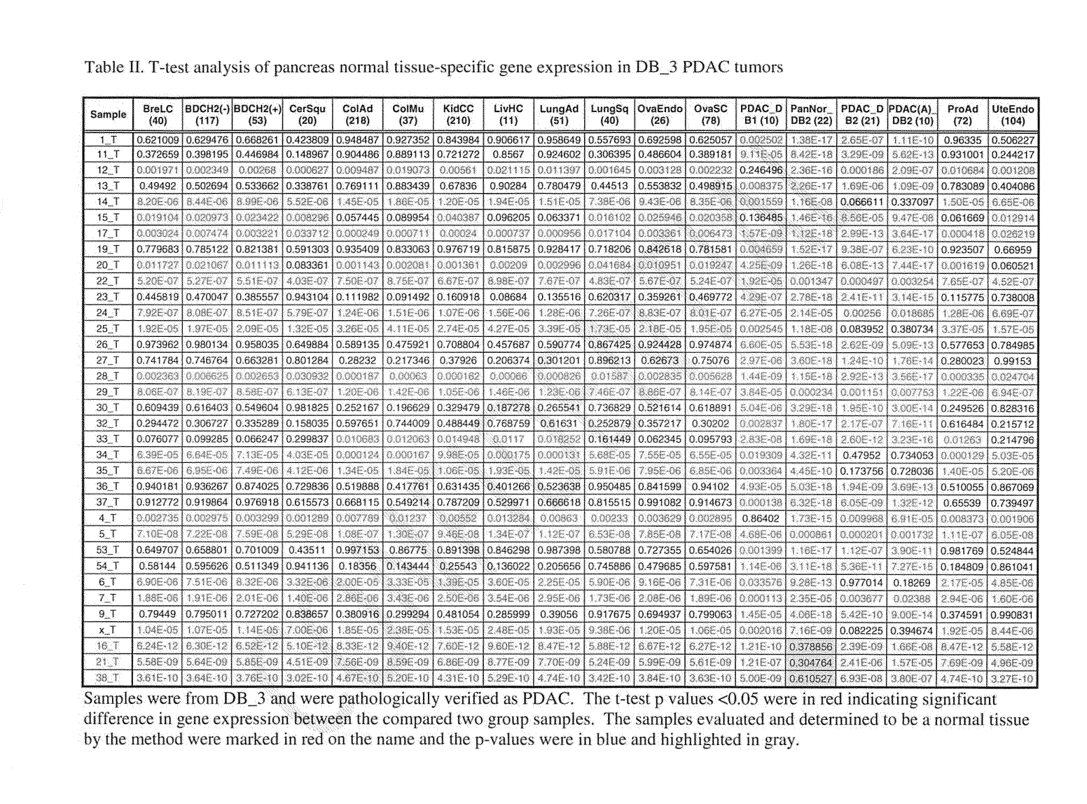

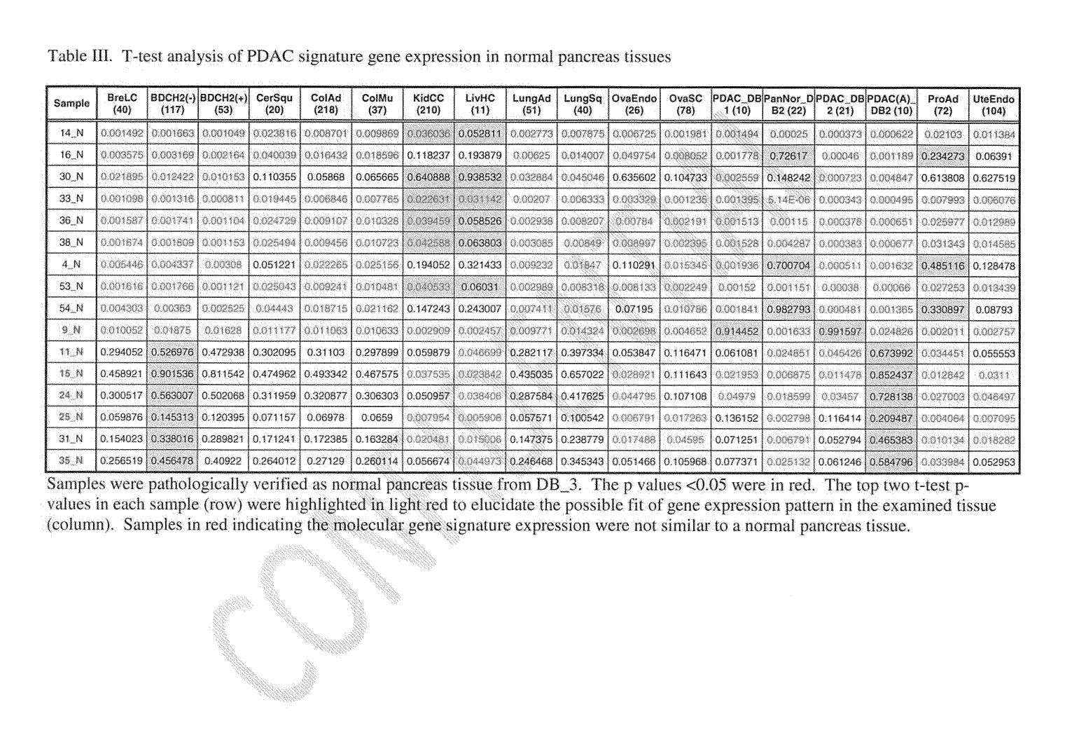

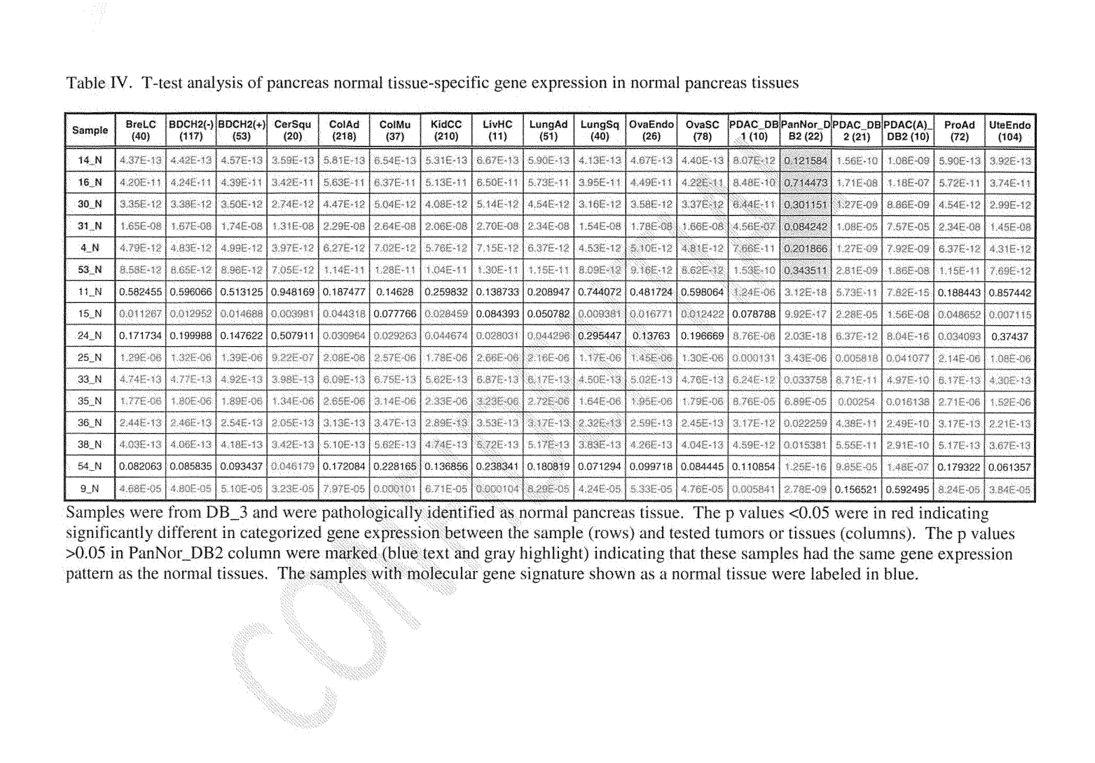

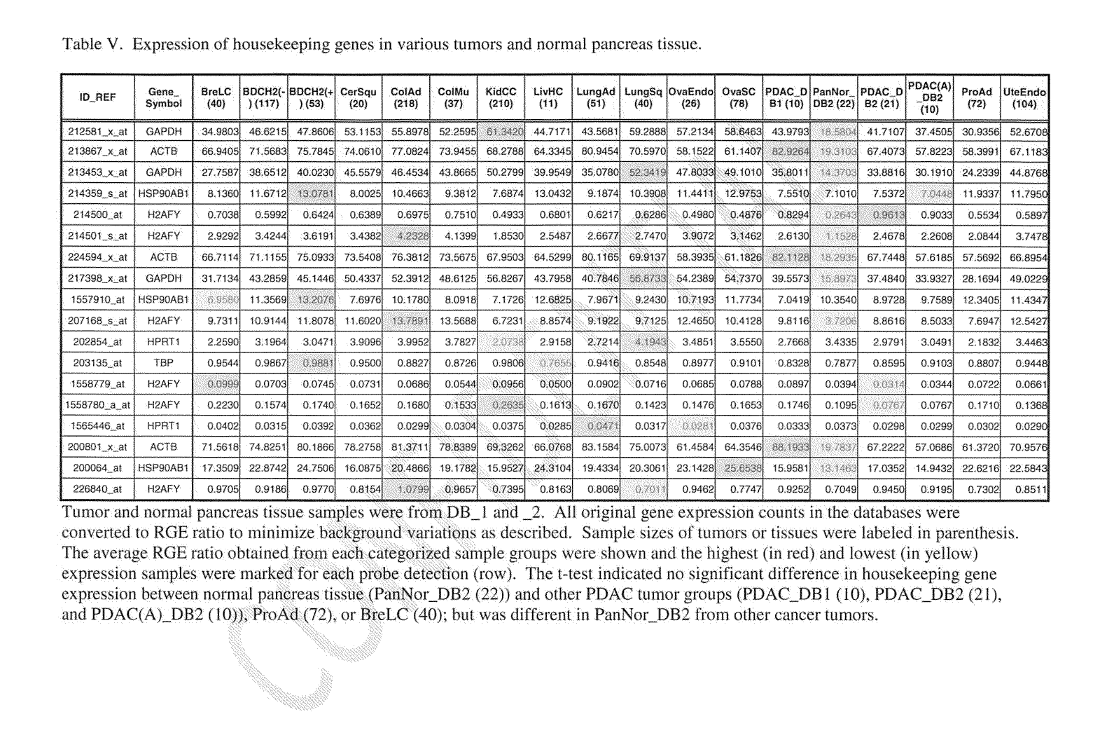

The expressions of identified five PDAC signature genes (8 probes) in GSE21501 dataset were compared to the profile present in various cancers. According to the t-test of the expression of those genes between PDAC patient samples and other types of cancers, patients could be distinguished into five distinct subgroups. Among them, the subgroup III and V representing the most and less differentiated PDAC, respectively. Their survival rate (subgroups III and V) was further analyzed, compared, and graphed in FIG. 9.

FIG. 9 is a diagram showing a survival time analysis of patients in subgroups III and V. There was a statistically significant difference between survival curves (P=0.049). As expected, patients in subgroups III with the most differentiated PDAC had significantly shorter predicted survival time than those at an early stage in subgroup V.

Patient data from GSE2109 are used as an initial group to demonstrate the improvement of the processes and evaluate the validity of the method. In order to faithfully distinguish differential expression between any two sample groups, FPR was first estimated. Patient data from ColAd was randomly divided into two equal groups to determine the background rate of detecting genes which were differentially expressed. A student two-tails t-test was used for the analysis. Though in theory, none should be found. About 0.1 to 0.2% equivalent to 50˜100 genes in total of 54,676 gene probes (GPL570) analyzed were detected. According to this estimated FPR, the frequency of randomly finding a gene differentially expressed in PDAC but not in 10 other cancers compared in parallel should be negligible ((0.001-0.002)¹⁰=1-2×10⁻³⁰). Using the method of comparing multiple sets of t-test, the FPR can be reduced to minimal and eliminated out those nonspecific background genes. Thus, the subsequently identified and characterized genes should be truly differentially expressed and be specific for the disease. During the initial investigation of PDAC in GSE2109 (PDAC_DB1, N=10), 11 genes were found fit in the criteria.

The reliability of using this method in gene signature characterization was accessed by a second database (DB_{—}2, GSE15471) containing PDAC (N=36) and normal pancreas tissue (N=22). The t-test analysis was performed between the second set of patient samples and other types of cancer from GSE2109. The same 11 genes were detected with differential expression in samples from DB2 dataset. Conceptually, if the 11 identified genes were genuine signature for PDAC and all the samples were correctly characterized as PDAC, then there should be no differences in the expression profile of this group of genes among the second set of PDAC samples. Every tumor samples from DB2 dataset were thus back checked with the method to verify the accuracy and efficiency. In fact, 21 of 36 (58.3%) tumor samples [PDAC_DB2(21)] had the same undistinguishable expression pattern of this group genes. Five tumor samples (13.9%) showed normal pancreas tissue expression pattern instead of PDAC and another ten (27.8%) samples had no similarity to PDAC or normal pancreas tissue profiles. They had altered gene expression profile and were then grouped as PDAC(A)_DB2(10) to distinguishes them from PDAC_DB2(21) group.

Samples of the PDAC_DB2(21), which showed the similar expression profile of the 11 identified genes as of PDAC_DB1(10), were reanalyzed by the method described above (FIG. 2). The goal was to verify if the same signature genes could be identified repeatedly by using other datasets. Five, instead of 11, genes were identified from the dataset including MMP11, COL10A1, INHBA, COL5A1, and HNT (from eight gene probes). All of them were found in the originally identified 11 genes suggesting that was a reliable and efficient method in finding signature genes. Certainly, removing samples which did not show the same expression pattern improved the efficiency and specificity in identifying signature genes. Those genes were all differentially up-regulated. None of them was down-regulated significantly in PDAC. In DB_{—}2 dataset, the expression pattern of normal pancreas tissue was also examined. Total of 1020 genes (from 1306 probes) were found differentially up-regulated in normal pancreas tissues, not in other types of cancer.

Given that the gene signature for a disease were specific, the expression profile of those genes should be able to verify the presence or to determine the status of the disease Data from a third database (DB_{—}3, GSE16515) were applied to evaluate the value of using these five signature genes for the disease diagnosis and prediction. Again, t-test was performed to examine if samples from the third group had any differences in expression of those categorized signature genes (5 genes, 8 probes for PDAC). The result was summarized in Table I. Total 24 of 35 (>68%) tumor samples in DB_{—}3 exhibited the same PDAC signature gene expression profile as that established in the earlier studies using PDAC_DB1(10) and PDAC_DB2(21) samples (t-test, p>0.05). Nine tumor samples (26%) had low or no similarity to the classified PDAC signature gene expression, but showed a profile similar to those cancer samples, PDAC(A)_DB2, with altered expression. One sample (5_T) had no expression similarity to PDAC (Table I) or normal pancreas samples (Table II) and the other one (16T) showed a profile as normal pancreas tissue (Table II), not a PDAC. In addition, two tumors (21 and 38_T) had mixed normal and PDAC tissues (Table I & II).

Samples of normal pancreas tissue (N=16) from D B 3 were also examined by the method. Six of them (14_{—}16_{—}, 30_{—}, 31_{—}, 4_, and 53_N) (37.5%) had undistinguishable expression profile as the normal pancreas tissue genes (Table III). The other six samples (11_{—}, 15_{—}, 24_{—}, 25_{—}, 31_, and 35_N) had an altered tumor gene expression profile similar to that of PDAC (A)_DB2 group (Table IV). This data indicated that some small tumors might be already present in tissues of which were pathologically classified as normal. Four samples (33_{—}, 36_{—}, 38_, and 54_N) did not show any gene expression similarity to PDAC, altered PDAC, or normal tissue profiles. One sample (9_N) had classic PDAC signature gene expression profile (Table IV) but not a normal one (Table III).

The expression profile of those five signature genes could predict the prognosis of PDAC. The expression of those five genes in the patient samples of GSE21501 (N=134) dataset was analyzed and compared to that established data of PDAC. Five distinct subgroups were categorized according to the signature gene expression profile. Patient samples in subgroup I had no similarity in those five gene expression to both PDAC patient groups. Subgroup II only had the best estimated similarity to the altered PDAC expression. Patient samples identified in both subgroup I and II might be tumors from other origin rather than the pancreas, or, at a stage of PDAC when altered gene expression profile was evident. However, patient samples in subgroup III, IV, and V had high expectation of gene expression profile similar to characterized PDAC patients. The subgroup III samples were clearly not normal pancreas tissue and quite distinctly different from other types of cancer. On the other hand, the subgroup V though had high expression profile as of PDAC, their expression, however, was not significantly different from that of other cancer types, nor of the normal tissues. Thus, the subgroup V could represent the least differentiated PDAC and patients in the subgroup III had the most differentiated PDAC tumor. Interestingly, while examining the survival rate of these patients, subgroup V patients had preferred survival time than of subgroup III (FIG. 9). The difference was statistically significant. Apparently, the expression profile of these five signature genes could be used to categorize the PDAC disease status and to predict patient prognosis.

It is apparent that the identified gene signature for PDAC and the established gene expression profile can be applied to all the patient of PDAC in datasets from various groups. Such gene signature is true for PDAC with high specificity.

Microarray is a powerful instrument for the study of molecular functions in cells. Because of the small sample size relative to the number of genes analyzed, the significance of array data is always a concern. Combining data from different array datasets although can increase the sample size, background incompatibility owing to the system bias restricts the use of this approach. Here, by converting array data to a ratio of averaged total gene expression, our study demonstrated that data conversion is an effective method to minimize background variations between datasets. Such modified data from different datasets then can be pooled and statistically analyzed as long as the samples were biologically relevant. It was a surprise to learn that the average counts of total gene expression between any two samples could have 30% or more in difference; even they were collected from the same dataset. Apparently, the background variations as previously mentioned between different databases can also occur within the same dataset and contribute to the array data heterogeneity as well. Since the expression of each gene within cells is expected to maintain at a relatively consistent level, any change in expression level shall indicate a differential expression.

Given at least two logs of difference between the sample size (in hundreds or less) and genes analyzed (>10,000) in array data, the finding of false positive genes is inevitable. Equally divided colon cancer samples were used to measure the false positive rate and it was estimated 0.1-0.2% between the two theoretically identical groups. Thus, when two t-test results were side-by-side compared, e.g. PDAC/LungAd and PDAC/ProAd pairs, the probability of randomly finding a gene differentially expressed in one disease (PDAC) but not in the other two (LungAd or ProAd) will be (1-2×10⁻³)²=1-4×10⁻⁶. It is conceivable that background will be eventually negligible when more pairs of comparison are aligned in a serial analysis. Consequently, specific genes can be effectively identified and selected. Among those five identified PDAC signature genes, three of them were detected by two different probes, indicating that the selection was not a randomized process. The expression of these genes were truly differential in PDAC. They all significantly increased in PDAC, but not in any other types of cancer. In addition, data from two independent datasets resulted in the same group of signature genes, suggesting a reliable and effective method for gene signature identification.

The method detected more than a thousand genes differentially expressed in the normal pancreas tissue. The reasons for identifying large numbers of normal pancreas-specific genes could be following: 1) The majority of pancreas-specific genes were down regulated during tumorigenesis. For example, there were at least 20 of such genes (detected from 23 probes) which were radically down-regulated during tumorigenesis, but their expression remained high enough to be differentially identified from other types of cancer. For those completely down-regulated genes, they would not be selected from the tumors. In addition, this data suggests a dedifferentiation process during the PDAC tumorigenesis. 2) Some of those genes were tumor suppressors. They were generally down-regulated in cancers. If more samples from various types of normal tissues were included in the analysis, those suppressors/regulators commonly found in normal tissues would be subtracted out from the list. Nonetheless, all the PDAC signature genes had significantly higher expression in tumors than in the normal pancreas. They could be suitable markers for the diagnosis and potential targets for the treatment of PDAC.

The identification of these genes were not resulted from systematic biases such as source bias (i.e. from different institutions because of variant RNA preparation protocols) or batch bias (i.e. different array platforms and hybridization variations) between datasets as suggested in other study (Bioinformatics (2004) 20:105-114). Samples from three different datasets (DB1, 2, and 3) all revealed the same results indicated the reliability and usefulness of this method in signature gene identification.

Our data showed that the molecular expression profile did not always agree with the pathologically characterized phenotype. For example, more than 60% (10 out of 16) of pathologically identified normal pancreas tissues did not present the normal tissue expression profile (Tables III and IV), whilst about 90% tumors had the same expression profile as PDAC or the other subgroup of pancreas tumor (PDAC(A)_DB2) with altered gene expression. About 37.5% (6 out of 16) of normal and 25.7% (9 out of 35) of tumor tissues from PDAC_DB3 showed the same profile as PDAC(A)_DB2 suggesting that these tissues could be at a precancerous stage, an early stage of tumor development, another subtype of PDAC, or pancreatitis. That needs to be further evaluated biochemically and histologically. Apparently, there were more mismatched phenotype in the normal pancreas tissue group than that in the tumor group (Tables I and II). Likely they were early onset of developing tumors within these normal tissue samples, and could not be easily detected morphologically by histological ways. On the other hand, tumors which did not show typical PDAC expression profile might be at an early stage or were not well differentiated carcinomas. Their phenotype required to be further examined and classified. In addition, examining and studying the tumorigenesis of those tissues are necessary and helpful in elucidating their oncogenicity in vitro and in vivo. It is optimistic that the signature genes obtained from this approach could be used as markers for the disease diagnosis and status verification. It would be a great beneficial to patient treatment and economic for the correctly distinguishing and staging of the tissues while making a clinic decision.

Besides classifying the signature genes for diseases, the same method can be applied to categorize genes associated to cell functions or pathways. For example, the common housekeeping genes (GAPDH, ACTB, HSP90AB1, H2AFY, HPRT1, and TBP; total 18 gene probes) were selected to evaluate their expression level in pancreas normal tissues and diseased samples (Table V). There were no differences in expression of those housekeeping genes among the normal pancreas tissue (PanNor_DB2) and other PDAC, BreLC, or ProAd tumors. However, the housekeeping genes do have different level expression while comparing to other types of tumor such as colon, kidney, liver, ovary, and lung cancers. This result strongly indicates that the expression profiles of housekeeping genes vary in different tissue cells. However, none of the probes for these housekeeping genes detected a differential expression in any specific disease. Conceptually, genes involved in cellular functions or pathways such as cell cycling, apoptosis, phosphorylation, or methylation etc. all can be selected from the gene table and grouped for statistical analysis. They should have differential expression of the genes which are involved in a specific pathway if the pathway is effective and responsible in altering cell functions. The other potential useful application is for personalized medicine. Cancer patients can have their primary tumor evaluated at a molecular level to determine whether their tumor gene expression profile agrees with the pathology specified disease and verify its status. Through the molecular investigation, it is possible to identify a specific expression pattern of signature genes from patient data and provide more choices in target selection for patient treatment. In addition, if the tumor is recurrent, the second tumor sample data can be compared to the patient's primary tumor profile and identify the gene(s) which changes and differs from the primary rumor. Thus, an altered treatment could be possibly chosen based on the molecular profile in tissues and hopefully it will be more specific and effective to restrain the recurrent tumors.

In summary, the conditions of sample cells are categorized and differentially grouped according to results of statistical analyses to define specified tissues, cells, or any organisms and to differentiate cells that have various conditions including conditions of normal function, abnormal function, or, a unique or mixed cell functions, cell stages, cell developments, cell modifications, cell transformation, or diseases.

According to above descriptions and drawings, this invention discloses a system to detect/identify/verify/confirm a specified cell condition such as pancreas cancer that includes an apparatus to carry out the step of identifying, verifying, confirming a specified cell condition such as pancreas cancer is carried out by two-tails t-test of the difference between the expression profile of categorized pancreas cancer (or any other types of diseases, abnormal cells or tissues, stages of cell, specific cell functions, and other undefined cellular functions such as the developmental process during embryogenesis) signature genes and the patient sample (or any other interested, specific tissue- and/or cell-type samples). In an embodiment, the categorized signature genes are genes significantly and differentially expressed in the samples with specified cell condition. In another embodiment, the expression profiles of identified signature genes are grouped and included in t-test to distinguish the differences of interested sample from the classified group. The classified group signature genes are identified from samples with a specified cell condition. In another embodiment, the identified signature genes are genes with significant differential expression within the samples under a specific interest cell condition. They may or may not be the cause for the phenotype of cell condition, but be exclusively expressed. For example, the “A” signature gene in pancreas cancer does not mean that “A” product must be the cause for pancreas cancer. In another embodiment, the identified signature genes of pancreas cancer include any of these five genes MMP11, COL10A1, INHBA, COL5A1, and HNT (from eight gene probes). In another embodiment, the signature genes identified for samples under various cell conditions are used for cell condition detection, identification, verification, confirmation, and/or other applications. In another embodiment, the identified signature genes and derived products (such as RNAs, protein or peptide, and their modifications, or, any artificially synthesized such products in vitro or in vivo) can be used as signals for disease identification, diagnosis, verification, confirmation, and prognosis prediction. The identified signature genes and its derived products can be used as signals for various cell condition detection, verification, and confirmation. In another embodiment, the identified signature genes and derived products are used as targets for disease treatment. In another embodiment, the identified signature genes and its derived products are modified for disease treatment or various applications. In another embodiment, the identified signature genes and its derived products can be antagonized for treatment or various applications. In another embodiment, the identified signature genes and its derived products can be used individually or in combination for various applications. In another embodiment, the identified signature genes and its derived products are used for drug development. In another embodiment, the identified signature genes and its derived products are used for antibody production. In another embodiment, the expression of identified signature genes and its derived products are altered by various methods. In another embodiment, the identified signature genes and derived products are applied to associate/interact with other gene products or derived products directly or indirectly.

This invention further disclosed a system to detect a specified cell condition related to a pancreas cancer comprising an apparatus to identify signature genes including any of a group of five genes comprising MMP11, COL10A1, INHBA, COL5A1, and HNT.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A method implemented in a data handling system for selecting a signature gene of a specific cell condition comprising:
performing statistical analyses on multiple gene datasets of various types of cell condition for identifying signature genes for at least one of the specified cell condition;
categorizing and establishing gene expression table with the signature genes; and
testing and verification of the signature genes in the gene expression table by applying additional data sets to finalize and confirm the signature genes.

2. The method of claim 1 wherein:
the step of performing the statistical analyses on the gene data sets of various types of cell condition further comprising a step of performing a total background normalization (TBN) to convert data to a relative gene expression (RGE) ratio then carried a two-tail T-test of the RGE ratios between the various sample groups of different cell conditions.

3. The method of claim 1 wherein:
the step of identifying the signature gene further comprising a step of carrying out a false positive elimination (FPE) by identifying differently expressed genes and removing overlapping genes among sample groups with different cell conditions from a list of the signature genes.

4. A system to detect/identify/verify/confirm a specified cell condition such as pancreas cancer comprising:
the step of identifying/verifying/confirming a specified cell condition such as pancreas cancer is carried out by two-tails t-test of the difference between the expression profile of categorized pancreas cancer (or any other types of diseases, abnormal cells or tissues, stages of cell, specific cell functions, and other undefined cellular functions such as the developmental process during embryogenesis) signature genes and the patient sample (or any other interested, specific tissue-and/or cell-type samples).

5. The method of claim 4 wherein:
the step of categorized signature genes are genes significantly and differentially expressed in the samples with specified cell condition.

6. The method of claim 4 wherein:
the expression profiles of identified signature genes are grouped and included in t-test to distinguish the differences of interested sample from the classified group. The classified group signature genes are identified from samples with a specified cell condition.

7. The method of claim 4 wherein:
the identified signature genes are genes with significant differential expression within the samples under a specific interest cell condition. They may or may not be the cause for the phenotype of cell condition, but be exclusively expressed. For example, the “A” signature gene in pancreas cancer does not mean that “A” product must be the cause for pancreas cancer.

8. The method of claim 4 wherein:
The identified signature genes of pancreas cancer include any of these five genes MMP11, COL10A1, INHBA, COL5A1, and HNT (from eight gene probes).

9. The method of claim 4 wherein:
the signature genes identified for samples under various cell conditions are used for cell condition detection, identification, verification, confirmation, and/or other applications.

10. The method of claim 4 wherein:
the identified signature genes and derived products (such as RNAs, protein or peptide, and their modifications, or, any artificially synthesized such products in vitro or in vivo) can be used as signals for disease identification, diagnosis, verification, confirmation, and prognosis prediction. The identified signature genes and its derived products can be used as signals for various cell condition detection, verification, and confirmation.

11. The method of claim 5 wherein:
the identified signature genes and derived products are used as targets for disease treatment.

12. the method of claim 5 wherein:
the identified signature genes and its derived products can be modified for disease treatment or various applications.

13. the method of claim 5 wherein:
the identified signature genes and its derived products can be antagonized for treatment or various applications.

14. The method of claim 5 wherein:
the identified signature genes and its derived products can be used individually or in combination for various applications.

15. The method of claim 5 wherein:
the identified signature genes and its derived products can be used for drug development.

16. The method of claim 5 wherein:
the identified signature genes and its derived products can be used for antibody production.

17. the method of claim 5 wherein:
the expression of identified signature genes and its derived products can be altered by various methods.

18. the method of claim 5 wherein:
the identified signature genes and its derived products can associate/interact with other gene products or derived products directly or indirectly.

19. A system to detect a specified cell condition related to a pancreas cancer comprising:
an apparatus to identify signature genes including any of a group of five genes comprising MMP11, COL10A1, INHBA, COL5A1, and HNT.
